(19) United States
(12) Patent Application Publication
(10) Pub. No.: US 2025/0283976 A1
(43) Pub. Date: Sep. 11, 2025

(54) Method for Operating a Measuring Device

(71) Applicant: Robert Bosch GmbH, Stuttgart (DE)

(72) Inventors: Andreas Koelsch, Peiting (DE); Andreas Frischen, Leonberg (DE); Anke Giliard, Stuttgart (DE); Benjamin Moster, Niefern-Oeschelbronn (DE); Heiko Sgarz, Leonberg (DE); Jan Linus Steuler, Woelfersheim (DE); Jonas Messner, Stuttgart (DE); Juergen Winterhalter, Stuttgart (DE); Kakit Law, Reutlingen (DE); Lukas Fiederer, Balingen (DE); Michael Brand, Berlin (DE); Sachin Lingadahalli Vittal, Viernheim (DE); Stephan Krane, Woerth Am Rhein (DE); Uwe Troeltzsch, Roesrath (DE)

(21) Appl. No.: 19/073,631

(22) Filed: Mar. 7, 2025

(30) Foreign Application Priority Data
Mar. 11, 2024 (DE) 10 2024 202 237.3

(51) Int. Cl. G01S 7/41; G01S 13/88

(52) U.S. Cl. CPC G01S 7/412; G01S 13/888

(57) ABSTRACT

A computer-implemented method for operating a measuring device, in particular a wall diagnostic device, includes (i) receiving radar data of a radar sensor unit of the measuring device, (ii) performing wall diagnostics by performing an analysis of the radar data and generating diagnostic results using a diagnostic module of the measuring device, (iii) performing an object recognition of an object disposed in the wall using the diagnostic module based on the radar data and taking into account the wall type classification results of the wall type, and (iv) providing the diagnostic results of the diagnostic module to a display unit of the measuring device for displaying the diagnostic results to a user of the measuring device.

This application claims priority under 35 U.S.C. § 119 to application no. DE 10 2024 202 237.3, filed on Mar. 11, 2024 in Germany, the disclosure of which is incorporated herein by reference in its entirety.

The present disclosure relates to a method for operating a measuring device, in particular a wall diagnostic device.

### BACKGROUND

Diagnostic devices for diagnosing walls and detecting objects formed in the walls are known in the prior art.

It is an object of the present disclosure to provide an improved method of operating a measuring device, in particular a wall diagnostic device.

The task is solved by the process set forth below. Advantageous embodiments are subject-matter also set forth below.

### SUMMARY

According to one aspect, a computer-implemented method of operating a measuring device, in particular a wall diagnostic device is provided, wherein the method comprises:
receiving radar data from a radar sensor unit of the measuring device, wherein the radar data depicts a wall to be diagnosed;
performing a wall diagnostics by performing an analysis of the radar data and generating diagnostic results via a diagnostic module of the measuring device, wherein the wall diagnostic comprises:
performing a wall type classification and providing wall type classification results of a wall type of the wall using the diagnostic module based on the radar data; and
performing an object recognition of an object disposed in the wall using the diagnostic module based on the radar data and taking into account the wall type classification results of the wall type, wherein the object recognition comprises an object detection and an object classification; and
providing the diagnostic results of the diagnostic module to a display unit of the measuring device for displaying the diagnostic results to a user of the measuring device, wherein the diagnostic results comprise at least one object position of the object in the wall and an object type of the object and/or the wall type of the wall.

The technical advantage can thereby be achieved that an improved method for operating a measuring device, in particular a wall diagnostic device, can be provided. To this end, based on radar data from a radar sensor unit of the measuring device that depicts a wall to be examined, a wall diagnostics is performed by performing a diagnostic module of the measuring device.

The wall diagnostics comprises performing a wall type classification, whereby the diagnostic module determines a wall type of the wall to be examined, and performing an object recognition, whereby the diagnostic module performs object detection and object classification of an object disposed in the wall based on the radar data and taking into account the previously determined wall type. Further, diagnostic results are provided for the wall diagnostics performed by the diagnostic module, wherein the diagnostic results comprise at least the wall type of the wall to be examined and/or an object position or object type of the object positioned in the wall.

By automatically determining the wall type of the wall to be examined, a more precise wall diagnostics can be provided. Further, it may be avoided that a wall type must first be determined manually by the user prior to performing the wall diagnostics. In this context, it may further be avoided that the user sets the wrong wall type, which would adversely affect the diagnostic results. By incorporating the wall type automatically determined by the diagnostic module into the object recognition, a more precise object recognition can be provided.

Different wall types affect the radar data received from the measuring device, so that effects of the wall type, for example in a subsurface correction, can be taken into account or corrected for the radar data in the object, in order to be able to perform the object recognition independent of the present wall type. This may increase the quality of the wall diagnostics performed.

According to one embodiment, the received radar data comprises a plurality of radar signals of different frequencies reflected by the wall, and wherein the received radar data is summarized into a plurality of windows.

The technical advantage can thereby be achieved that, by evaluating the received radar data in a plurality of spatially larger windows, wall diagnostics may be performed based on the radar data for a larger spatial area. This accelerates performance of the wall diagnostics.

According to one embodiment, performing the wall type classification comprises:
performing partial classifications on individual windows of the radar data and providing partial classification results of the wall type; and
merging a plurality of partial classification results to an overall classification result and determining the wall type based on the overall classification result.

The technical advantage can thereby be achieved that a more precise wall diagnostics can be provided. For this purpose, a partial classification is performed based on the individual windows of the radar data, and partial classification results of the wall type are provided for each window. Subsequently, multiple contiguous partial classification results are merged to an overall classification result of the wall type, and the final wall type is determined based on the overall classification result.

By performing a stand-alone partial wall type classification for each window, precise partial wall type classification results can be generated. Particularly when moving the measuring device relative to the wall, during which the radar data is received or processed in the form of windows over a period of time, meaning that each depicts different positions of the wall, the partial classification for different positions of the measuring device relative to the wall and associated different areas of the wall can thus be used to independently determine the respective wall type.

This allows, on the one hand, a precise determination of the wall type and, on the other hand, detection of a change of the wall type in different areas of the wall to be examined. By merging the data, the respective wall type of the wall to be examined can be determined as the overall classification result. For example, when the wall type changes in different areas of the wall, the merger may comprise a corresponding weighting to account for any wall type changes that may be present or possible erroneous diagnostic results.

According to one embodiment, the merger is effected by performing a merger algorithm, and/or wherein the merger takes into account the partial classification results with a weighting with respect to the results of the object recognition.

The technical advantage can thereby be achieved that the merger algorithm or the weighted consideration of the partial classification results in the merger can take into account the quality of the individual partial classification results. The quality of the overall classification result or the quality of the wall type of the wall ultimately determined can thereby be increased. Partial classification results that deviate from the majority of the partial classification results may be taken into account with a lower weighting, respectively.

According to one embodiment, performing the wall type classification comprises:
storing the wall type classification results of the wall type;
comparing currently determined wall type classification results of the wall type with stored wall type classification results of the wall type; and
providing the current wall type classification results of the wall type if the current wall type classification results of the wall type are different from the stored wall type classification results of the wall type for a predetermined number of windows of the radar data.

The technical advantage can thereby be achieved that the wall type can be determined precisely. To this end, wall type classification results generated at earlier times are stored and wall type classification results generated at current times are compared with the stored wall type classification results.

If there is a deviation between the current wall type classification results, which correspond to the most recently determined wall type classification results, and the stored wall type classification results, which correspond to the respectively older wall type classification results, then the current wall type classification result which deviates from the stored wall type classification results, is only considered the actual wall type present if the current wall type classification result which deviates from the stored wall type classification results is confirmed by further measurements, i.e., wall type classification results determined later.

This may result in wall type classification results based on, for example, erroneous radar data or a faulty wall diagnostics which deviate from the previously determined wall type classification results due to this deviation being detected as erroneous and/or non-representative wall type classification results, and thus being disregarded. This may avoid erroneous wall diagnostics results.

Further, by constantly comparing the currently generated wall type classification results with the previously determined wall type classification results, any change in the present wall type of the wall to be examined can be determined and considered. This is particularly interesting in cases where large areas of the wall are examined by moving the measuring device along the wall. Because the change in wall type is taken into account in the wall diagnostics, a more precise wall diagnostics and in particular a more precise object recognition of the objects disposed in the wall can be achieved.

According to one embodiment, the radar data is received for a plurality of positions of the measuring device relative to the wall, wherein the method further comprises:

receiving movement data of a movement detection unit of the measuring device, wherein the movement data represents a movement of the measuring device relative to the wall between the plurality of positions of the measuring device relative to the wall.

The technical advantage can thereby be achieved that the relative movement of the measuring device relative to the wall can be detected by the movement data of the movement detection unit. By detecting the movement of the measuring device relative to the wall, an exact positioning of the measuring device relative to the wall can be determined. The positioning of the measuring device relative to the wall allows for precise object detection of objects over an extended area of the wall to be examined.

According to one embodiment, the method furthermore comprises:
checking, based on the movement data of the movement detection unit, whether a movement of the measuring device relative to the wall by a predefined distance has been detected;
if no movement has been detected, storing the radar data and performing the check once again; and
If movement by the predefined distance has been detected, performing the wall diagnostics based on the radar data using the diagnostic module.

The technical advantage can thereby be achieved that a precise wall diagnostics is enabled over an extended area of the wall to be examined. Here, a check is first carried out to determine whether a movement of the measuring device relative to the wall by a predefined distance has been detected based on the movement data of the movement detection unit. If such movement has not been detected, the radar data is initially stored and the check is performed once again.

If such movement has been detected, the wall diagnostics are performed based on the radar data using the diagnostic module. This allows the wall to be scanned in a step size defined by the predetermined distance. This allows for reliable wall diagnostics over an extended area of the wall.

According to one embodiment, the wall diagnostics further comprises:

summarizing sub-objects detected and classified to a contiguous object based on radar data received at different positions of the measuring device relative to the wall, if there is a predefined distance dependency between the sub-objects.

In this way, the technical advantage can be achieved that by summarizing the sub-objects detected and classified relative to the wall in the various positions of the measuring device based on the radar data into a contiguous object, a precise wall diagnostics is possible, including a precise object recognition. While moving the measuring device relative to the wall, the wall diagnostics are performed according to the embodiments described above.

For the movement segments defined according to the predefined distances, the partial results, i.e. partial objects of the object to be detected within the wall, are determined by the diagnostic module during the wall diagnostics. The classified partial objects here describe portions of an extended object that is depicted by movement of the measuring device relative to the wall in portions of the movement. By summarizing the correspondingly classified partial objects into an overall object, the extended object can be described and detected in detail. This allows for precise wall diagnostics and detection of extended objects.

According to one embodiment, the wall diagnostics further comprises:

performing an object depth determination using the diagnostic module and determining an object depth of the object in the wall, wherein the object depth is defined as a distance of the object to a surface of the wall.

The technical advantage can thereby be achieved that, based on the radar data of the radar sensor unit, an object depth of the object within the wall can be determined by the measuring device in addition to the object recognition. The object depth describes a distance of the object to a surface of the wall. The correspondingly configured diagnostic module may determine the object depth based solely on the radar data of the radar sensor unit.

According to one embodiment, the analysis of the radar data further comprises:

performing an object extension determination and determining an object extension of the object along a predefined direction via the diagnostics module.

The technical advantage can thereby be achieved that an object extension of the object detected in the wall is further enabled based on the radar data of the radar sensor unit. The object extension describes an extension of the object at least with respect to one spatial direction, preferably with respect to two spatial directions, especially preferably with respect to three spatial directions. This allows for a one-dimensional, preferably two-dimensional, more preferably three-dimensional extension information for the object located in the wall.

According to one embodiment, the wall diagnostics further comprises:
performing a pre-processing of radar data of the radar sensor unit and providing input data to a wall type classification module of the diagnostic module using a first pre-processing module;
performing the wall type classification based on the input data provided by the first pre-processing module and providing wall type information using a wall type classification module of the diagnostic module;
performing a pre-processing of the radar data and providing input data to an object recognition module of the diagnostic module in consideration of the wall type information using a second pre-processing module of the diagnostic module;
performing an object recognition based on the input data provided by the second pre-processing module and providing diagnostic results using the object recognition module.

The technical advantage can thereby be achieved that precise wall diagnostics are enabled by the correspondingly configured diagnostic module using the radar data of the radar sensor unit. By pre-processing the radar data of the radar sensor unit, the radar data can be brought into the form required for the wall diagnostics. Using a correspondingly configured wall type classification module, a corresponding wall type classification can be performed on the pre-processed radar data and the respective wall type of the wall can be determined.

An object recognition of an object disposed in a wall may be performed by an object recognition module based on the pre-processed radar data and taking into account the wall type provided by the wall type classification module. The object recognition module is configured to perform an object detection and object classification of the object disposed in the wall based on the pre-processed radar data and taking into account the provided wall type. The presented architecture of the diagnostic module allows for the most precise and reliable wall diagnostics for walls to be examined.

According to one embodiment, the measuring device further comprises at least one of an induction sensor and/or an eddy current sensor and/or a capacitance sensor and/or an AC current sensor and/or an NMR sensor and/or an ultrasonic sensor for providing additional sensor data, wherein the diagnostic module is configured to perform the wall diagnostics by taking into account the additional sensor data.

The technical advantage can thereby be achieved that, through further sensor data, additional sensors, each of which is configured to detect different physical variables, can provide additional information in addition to the radar data of the radar sensor unit, for incorporation into the wall diagnostics. This additional information, which is preferably complementary to the information of the radar data of the radar sensor unit, allows further precise specification of the wall diagnostics or the object recognition.

According to one embodiment, the diagnostic module comprises at least one correspondingly trained artificial intelligence configured to perform an object recognition and/or wall classification and/or object depth determination based on the radar data and/or the additional sensor data.

The technical advantage can thereby be achieved that, because the diagnostic module is formed as a correspondingly trained artificial intelligence, that is trained based on the radar data, or, if applicable, taking into account the information of the additional sensors, to perform an object recognition and/or a wall classification and/or an object depth determination and/or an object extension determination, a reliable and powerful diagnostic module can be provided. By using the artificial intelligence technique, precise wall diagnostics can be provided.

Provided according to one aspect is a computing unit configured to perform the method of operating a measuring device according to one of the preceding embodiments.

Provided according to one aspect is a computer program product comprising instructions that, when the program is executed by a data processing unit, cause the data processing unit to perform the method for operating a measuring device according to one embodiment.

### BRIEF DESCRIPTION OF THE DRAWINGS

Embodiments of the disclosure are described with reference to the following figures. The figures show:

FIG. 1 a schematic illustration of a measuring device according to one embodiment;

FIG. 2 a further schematic illustration of the measuring device according to a further embodiment;

FIG. 3 a further schematic illustration of the measuring device according to a further embodiment;

FIG. 4 a schematic illustration of a measurement of the measuring device according to one embodiment,

FIG. 5 a further schematic illustration of the measuring device according to a further embodiment;

FIG. 6 a further schematic illustration of a measurement of the measuring device according to one embodiment,

FIG. 7 a flowchart of a method for operating a measuring device according to one embodiment of the disclosure,

FIG. 8 a further flowchart of the method for operating a measuring device according to a further embodiment, and

FIG. 9 a schematic representation of a computer program product.

### DETAILED DESCRIPTION

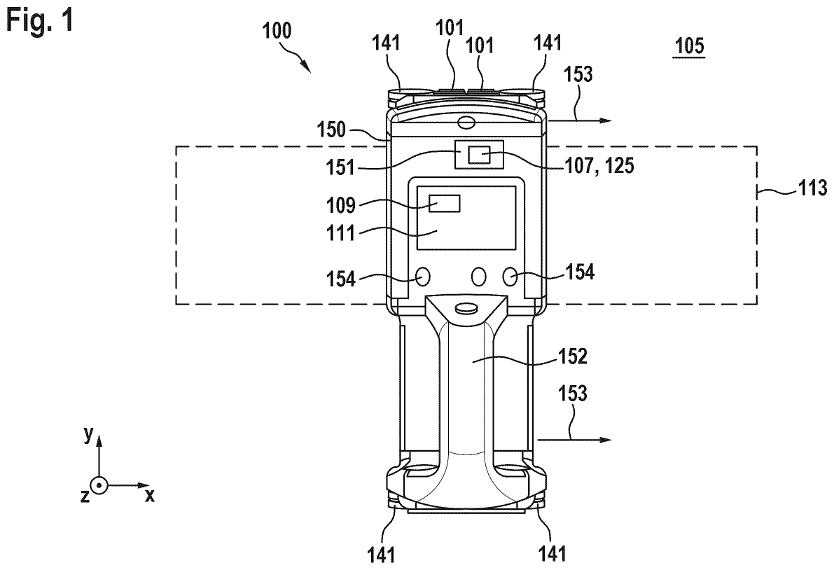

FIG. 1 shows a schematic representation of a measuring device 100 according to one embodiment.

The present disclosure relates to a measuring device, in particular to a wall diagnostic device for examining walls 105 to be processed. Wall diagnostic devices are known in the prior art that are used to detect objects disposed in walls. Such devices allow a user to examine walls to be processed to search for objects disposed in the walls in order to be able to perform planned work, for example drilling in walls, based on this such that damage to the objects disposed in the walls can be avoided.

In the embodiment shown, the measuring device 100 comprises a housing 150 having a handle 152 for grasping of the measuring device 100 by a user, a display unit 111 for displaying diagnostic results 109 of the wall diagnostics, and controls 154 for switching the measuring device 100 to various operating modes.

According to the disclosure, the measuring device 100 comprises at least one radar sensor unit 101. By way of the radar sensor unit 101, radar signals may be transmitted towards the wall 105 to be examined and radar signals reflected by the wall 105 may be received.

For example, the radar sensor unit 101 may be configured as a narrow band radar detector device in the 2.4 GHz to 2.4835 GHz frequency range or as an ultra-wide band radar detector device in the 1.8 GHz to 5.8 GHz frequency range.

The measuring device 100 further comprises a diagnostic module 107 executable on a computing unit 151 of the measuring device 100 to perform the wall diagnostics. The diagnostic module 107 is configured to perform a corresponding diagnosis of the wall to be examined based on the radar data 103 of the radar sensor unit 101. The radar data 103 of the radar sensor unit 101 thereby depicts the wall 105 to be examined and, if applicable, objects 113 disposed within the wall 105.

The wall diagnostics carried out by the diagnostic module 107 comprises at least performing an object recognition. The object recognition here comprises an object detection and an object classification of the object 113 disposed in the wall 105. The object detection comprises at least the determination of an object position 115. The object position here describes the positioning of the object disposed in the wall 105 with respect to a reference system defined by the measuring device 100. The object classification of the detected object 113 comprises at least determining an object type 117 of the detected object 113.

The diagnostic results of the wall diagnostics determined in this way, i.e. at least the determined object position 115 and/or the determined object type 117 of the object 113 disposed in the wall 105, are subsequently presented in a display unit 111 of the measuring device 100 to a user of the measuring device 100. For example, the display unit 111 may be configured as a corresponding display and the diagnostic results 109 may be visually displayed. Additionally, the display of the diagnostic results 109 may be supported via audible and/or haptic signals. For example, the haptic signals may be realized via corresponding vibration signals.

The object 113 can be shown in the display, for example, by way of a corresponding icon. The object 113 can be shown in the corresponding object position 115 in the display. The object extension 121 may be visualized by a corresponding size of the displayed icon. The particular object type 117 of the object 113 may be visualized with a corresponding term or color highlighting of the icon, or by a specific shape of the icon representing the object 113.

Alternatively, the wall diagnostics may additionally comprise determining a wall type 123 in the form of a wall type classification of the wall 105 to be examined. The wall type 123 describes the respective type of the wall 105 to be examined. For example, the wall type may be associated with corresponding wall type classes, which may comprise: Concrete wall, plasterboard/drywall wall, brick wall and/or wall bricks, underfloor heating, wall heating or similar wall types found in buildings.

According to one embodiment, the diagnostic module 107 is further configured to determine an object depth 119 of the object 113 within the wall 105 based on the radar data 103. The object depth 119 is defined by a distance of the object formed in the wall 105 to a surface of the wall 105. The distance may be defined on the object side, for example with respect to an object surface or with respect to an object center point. The distance to the surface of the wall 105 describes a shortest distance defined by a direction perpendicular to the surface of the wall 105.

According to one embodiment, the diagnostic module 107 is further configured to determine an object extension 121 of the object 113 in at least one predefined direction based on the radar data 103. The object extension 121 of the object 113 describes a spatial extension of the object 113 in at least one spatial direction, preferably in two spatial directions, particularly preferably in three spatial directions. The object 113 may be described here as a one-dimensional, two-dimensional, or three-dimensional object 113.

In conventional use, the measuring device 100 is placed on the surface of the wall 105 to be examined. Radar signals are transmitted towards the wall 105 and radar signals reflected from the wall 105 or the objects 113 disposed there are received via the radar sensor unit 101. This radar data 103 of the radar sensor unit 101 is used by the diagnostic module 107 to perform the wall diagnostics described above and to determine corresponding diagnostic results 109.

For example, diagnostic results 109 may comprise the object position 115 and/or object type 117 of the object 113 disposed in the wall 105. Alternatively or additionally, the diagnostic results 109 may comprise the wall type 123 of the wall 105 and/or the object depth 119 and/or the object extension 121 of the object 113.

The diagnostic results 109 configured in this manner may subsequently be displayed to a user of the measuring device 100 in a display unit 111 of the measuring device 100. The display unit 111 can be configured as a corresponding display, for example. The diagnostic results 109 may be displayed in graphical or textual form in the display unit 111.

According to one embodiment, the measuring device 100 further comprises a motion detection unit 141. The motion detection unit 141 may be used to detect movement of the measuring device 100 relative to the wall 105. The motion detection unit 141 may comprise, for example, at least one roller element for this purpose. When the roller element is placed on the wall surface of the wall 105, movement of the measuring device 100 relative to the wall 105 can be detected when the measuring device 100 moves along a direction of movement 153 by rolling the roller element. Alternatively, the motion detection unit 141 may have a different configuration by which a relative movement of the measuring device 100 relative to the wall 105 can be detected.

By moving the measuring device 100 relative to the wall 105, radar data 103 of the radar sensor unit 101 may be captured for a plurality of different positions of the measuring device 100 relative to the wall 105. This allows a larger spatial area of the wall 105 to be examined than that given by the effective range of the radar sensor unit 101. This allows for objects 113 to be captured that have a greater spatial extent than the effective range of the radar sensor unit 101.

While the measuring device 100 moves along the direction of movement 153, radar data 103 of the radar sensor unit 101 may be captured continuously. The wall diagnostics may be evaluated by the diagnostic module 107 based on this radar data 103 while the measuring device 100 is moving along the direction of movement 153. This allows for accelerated wall diagnostics, taking into account the positioning of the measuring device 100 relative to the wall 105.

According to its embodiment, the diagnostic module 107 is configured as a correspondingly trained artificial intelligence 125. The artificial intelligence 125 is trained to perform the above-described wall diagnostics based on the radar data 103 of the radar sensor unit 101 and to determine at least the object position 115 and the object type 117 of an object 113 disposed in the wall 105. The object classification or determination the object type 117, respectively, comprises assigning the detected object 113 to predefined object classes.

The object classes may comprise: Metal/non-metal object, low voltage cable, single phase AC signal cable, multi phase AC signal cable, wood beam, metal beam, plastic pipe, water filled plastic pipe, for example fresh water pipe, non-water filled plastic pipe, for example waste water pipe, or other elements commonly installed in building walls.

Further, the artificial intelligence 125 may be trained to determine the wall type 123 of the wall 105 to be examined at least based on the radar data 103 of the radar sensor unit 101. Possible wall types 123 may comprise: Concrete wall, plasterboard/drywall wall, brick wall and/or individual bricks of the brick wall, underfloor heating, wall heating or other similar wall types commonly installed in buildings.

According to one embodiment, in addition to the radar sensor unit 101, the measuring device 100 may comprise further additional sensors by way of which additional physical variables are detectable. For example, the measuring device 100 may comprise an induction sensor and/or an eddy current sensor and/or a capacitance sensor and/or an AC current sensor and/or an NMR sensor and/or an ultrasonic sensor or other sensors commonly used in wall diagnostic devices.

The diagnostic module 107, in particular the corresponding trained artificial intelligence 125, can be configured to perform wall diagnostics based on the radar data 103 of the radar sensor unit 101 and taking into account the additional sensor information of the further sensors described above. The additional information of the additional sensors mentioned above can in particular be used for object recognition of the objects 113 disposed in the walls 105. The additional sensor information may possibly provide improved detection of the objects 113 and may possibly provide improved classification of the objects 113.

In particular, for example, the material of the objects 113, for example as a metallic or non-metallic material, can be improved and classified by using the additional sensor information.

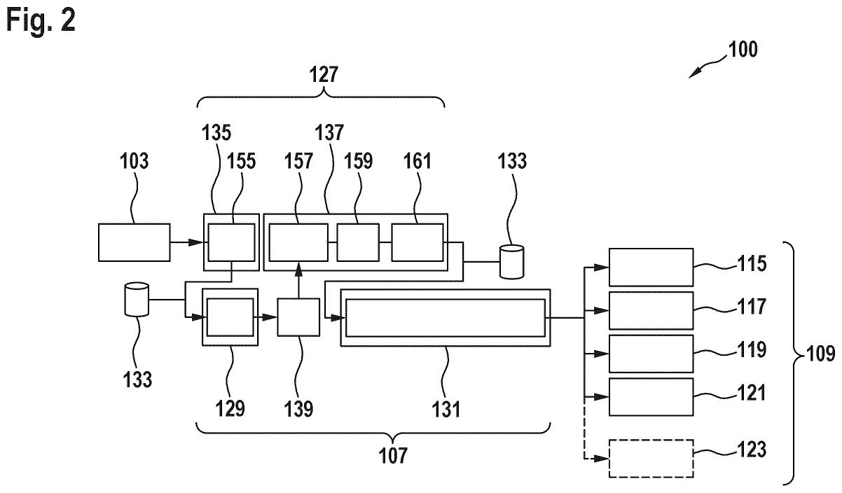

FIG. 2 shows another schematic representation of the measuring device 100 according to a further embodiment.

In the embodiment shown, the measuring device 100 comprises a pre-processing module 127 in addition to the diagnostic module 107. For wall diagnostics, the measuring device 100 first receives the radar data 103 of the radar sensor unit 101. Pre-processing of the receiving radar data 103 is performed via the pre-processing module 127. For example, via pre-processing of the pre-processing module 127, the radar data may be brought into a corresponding data structure required for wall diagnostics by the diagnostic module 107.

As described above, during wall diagnostics, the diagnostic module 107 generates the diagnostic results 109 described above. For example, the diagnostic results 109 may comprise the object position 115 and/or object type 117 and/or object depth 119 and/or object extension 121 of an object 113 formed in the wall to be examined 105 and/or the wall type 123 of the wall 105 to be examined. The correspondingly generated diagnostic results 109 may subsequently be displayed in the display unit 111 of the measuring device 100.

According to one embodiment, in addition to the radar data 103 of the radar sensor unit 101, the additional sensor information of the additional sensors described above may be included in the wall diagnostics of diagnostic module 107. A corresponding pre-processing of the additional sensor information may be performed accordingly by the pre-processing module 127.

In the embodiment shown, the diagnostic module 107 comprises a wall type classification module 129 and an object recognition module 131. The pre-processing module 127 comprises a first pre-processing module 135 and a second pre-processing module 137. The first pre-processing module 135 comprises an S matrix reduction 155. The second pre-processing module 137 comprises a background correction 157, an inverse Fast Fourier transformation 159, and a focusing and migration 161. In the pre-processing of the radar data 103 by the pre-processing module 127, the radar data 103 is first pre-processed by the first pre-processing module 135 and the S-matrix reduction 155 contained therein.

When doing so, the first pre-processing module 135 generates input data 133 based on the radar data 103. The input data 133 serves as input data for the wall type classification module 129. The wall type classification module 129 performs a wall type classification of the wall 105 to be examined based on the input data 133 and generates wall type information 139. The wall type information 139 contains the wall type 123 of the wall 105 to be examined, as determined in the wall type classification.

Subsequently, the second pre-processing module 137 performs pre-processing based on the radar data 103 and the wall type information 139. A background correction 157 of the radar data 103 is performed during this, taking into account the wall type 123 determined in the wall type information 139. Depending on the wall type 123 of the wall 105 to be examined, different effects on the radar data 103 can occur.

These effects, which are primarily based on the respective wall type 123 and can affect object recognition, can be corrected by the background correction 157. After the background correction has been performed, further pre-processing can be carried out by performing the inverse Fast Fourier transformation 159 or focusing and migration 161, respectively, and input data 133 can be created for the object recognition module 131 once again. Based on the input data 133 provided by the second pre-processing module 137, the object recognition module 133 performs the object recognition of the object 113 disposed in the wall 105 to be examined and determines at least the object position 115 and the object type 117 of the respective object 113. Additionally, the object depth 119 and the object extension 121 may be determined by the object recognition module 131.

According to one embodiment, the diagnostic module is further configured to determine an object depth of the object within the wall based on the radar data, wherein the object depth is defined by a distance of the object formed in the wall to a surface of the wall.

The pre-processing is optional. Depending on the algorithm used for the diagnostic module 107, completely unprocessed

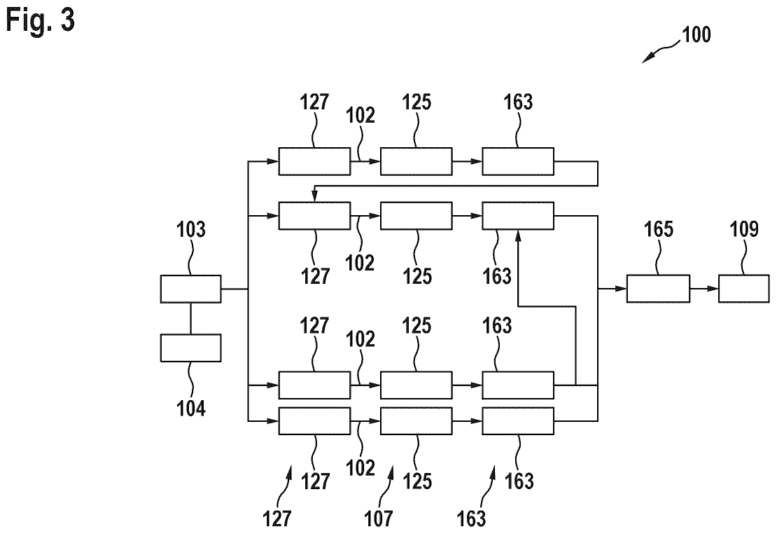

radar echoes of different frequencies may be used as radar data 103 and as input data for the diagnostic module 107. Alternatively, radar data 103 processed via multiple steps may be used. The pre-processing steps comprise, for example, the transformation of the
signals from the frequency domain to the time or distance domain, background deduction, noise removal, and normalization of the signals. For radar data 103 which is available in the form of complex numbers, only the absolute value can be processed. Alternatively or additionally, the phase information may be considered.
FIG. 3 shows a further schematic representation of the measuring device 100 according to a further embodiment.

In the embodiment shown, the diagnostic module 107 comprises a plurality of parallel processing paths 102. Each processing path 102 includes a pre-processing module 127, the diagnostic module 107, for example, comprising the wall type classification module 129 and/or the object recognition module 131 according to the embodiment in FIG. 2, and a post-processing module 163.

In FIG. 3, primarily the radar data 103 is shown as input data for the wall diagnostics. In addition to the radar data shown, however, the additional information of the additional sensors may also serve as input data for the wall diagnostics. Here, the different information from the different types of sensors in the different parallel processing paths 102 can be processed and the corresponding wall diagnostics performed separately on the different sensor information. Upon completion of the wall diagnostics, a summary module may be used to assemble a summary of the individual sub-analysis results to form the diagnostic results 109 of the wall diagnostics.

Alternatively or additionally, different sub-aspects of the wall diagnostics may be performed by the different processing paths 102 based on the same sensor information.

For example, the individual processing paths 102 may process different radar data 103 captured during movement of the measuring device 100 relative to the wall 105 for different positions of the measuring device 100 relative to the wall 105. The radar data 103, thus representing different regions of the wall 105 and captured sequentially in time as the measuring device 100 moved relative to the wall 105, may then be processed in the different processing paths 102 by the modules shown.

The different processing paths perform a stand-alone wall diagnostics in this respect, comprising at least determining the object position 115 and/or the object type 117 of the object 113 disposed in the wall 105.

The summary module 165 may summarize the sub-results provided in the individual processing paths 102 of the stand-alone wall diagnostics of the different regions of the wall 105 into a contiguous diagnostic result 109. The contiguous diagnostic result here describes the wall diagnostics of a contiguous spatial area that was covered during movement of the measuring device 100 relative to the wall 105 and depicted by the corresponding captured radar data 103. The parallel processing of the radar data 103 or additional sensor information 104 of the additional sensor elements in the different processing paths 102 thus enables accelerated wall diagnostics.

Alternatively, various wall diagnostic functions may also be performed in the different processing paths 102. For example, in one processing path 102, the wall type classification and the determination of the wall type 123 of the wall 105 to be examined can be performed. In another processing path 102, object recognition of the object disposed in the wall 113 can be performed. The object detection can be performed with the determination of the object position 115 and the object classification can be performed with the determination of the object type 113 in one processing path 102.

Alternatively, the object detection and object classification may then also be performed in two separate processing paths 102. In further processing paths 102, the object depth determination, i.e., the determination of the object depth 119 and/or the determination of the object extension 121 may respectively be carried out. In the summary module 165, the various sub-results of the wall diagnostics may be summarized into corresponding diagnostic results 109.

The diagnostic module 107 can be divided into different artificial intelligences 125, as already shown in the embodiment in FIG. 2. For example, the diagnostic module 107 may comprise a wall type classification module 129 and an object recognition module 131. The object recognition module may in turn be divided into an object detection module and an object classification module. The diagnostic module 107 may further comprise an object depth determination module and object extension module, respectively configured to determine the object depth 119 and the object extension 121.

The respective modules may each be configured as stand-alone artificial intelligences 125, for example, neural networks. Alternatively, the various modules may form portions of an overall artificial neural network that are connected to an overall neural network according to structures known in the prior art.

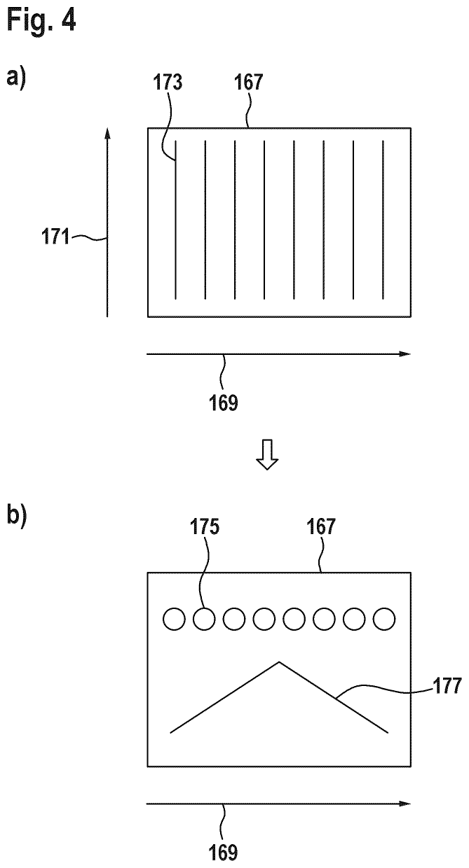

FIG. 4 shows a schematic illustration of a measurement of the measuring device 100 according to one embodiment.

For pre-processing, the radar data 103 or the additional sensor information 104 of the remaining sensors may be normalized, in particular to numerically stabilize the subsequent steps performed by the diagnostic module 107 during wall diagnostics. For example, an amplitude and/or offset compensation may be performed for this purpose. Further, to reduce interference, filtering of the radar data 103 may be carried out, and to reduce the data rate the corresponding sensor data may be sampled. Further, the radar data 103 or the additional sensor information 104 may be transformed to the respective required frequency range or time range. Methods known from the prior art can be used for this purpose.

Further, the captured radar data 103 or additional sensor information 104 may be divided into temporal or spatial windows 167. Temporal windows 167 may be generated by recording the radar data 103 or the additional sensor information or the pre-processed radar data 103 over a fixed time interval. Spatial windows 167, on the other hand, may be generated from a mapping of the radar data 103 or additional sensor information 104 to positions of the measuring device 100 relative to the wall 105 along the direction of movement 153.

Graph a) of FIG. 4 shows such a data matrix resulting from the steps described above. The data matrix of the window 167 shown in graph a) shows a plurality of sensor data, which may comprise, for example, radar data 103 or additional sensor information 104 of the further sensors plotted along a frequency channel axis 171 or along a space/time axis 169, respectively.

A width of the temporal windows 167 may be selected such that different sampling rates of the sensors may be balanced and a new window 167 may be provided frequently enough so that a display of the diagnostic results 109 of the wall diagnostics in the display unit 111 may be shown without too great of a time delay while the measurement is being performed or shortly after the measurement of the measuring device 100 ends.

A rate of 2 to 20 windows per second of the data recording of the sensor data may be advantageous for this purpose. For spatial windows, the spatial sampling rates can be selected to achieve the desired local accuracy. Advantageously, 1 mm to 1 cm sampling rates can be used. This means that corresponding sensor data is captured every 1 mm to 1 cm of movement of the measuring device 100 along the direction of movement 153.

A width of the spatial windows 167 may be selected such that contiguous information relating to an object 113 is contained in a window. Advantageously, a width of the respective spatial windows 167 can be 1 cm to 20 cm. This results in 4 to 100 measured values per window 167. This allows for further efficient algorithmic processing of the correspondingly recorded radar data 103 or additional sensor information by the diagnostic module 107.

A further temporal window 167 or spatial window 167 can be provided as soon as one or more scan points are available.

The diagnostic module 107 may be oriented such that a matrix corresponding to the window size of the respective spatial or temporal window 167 may be included as input data, for example of each processing path 102 of the embodiment in FIG. 3 as well. According to the embodiment of FIG. 2, the corresponding input data can comprise the respective pre-processed sensor data, i.e. radar data 103 and additional sensor information 104 of the additional sensors.

As stated above, wall diagnostics may be performed by the diagnostic module 107 based on a correspondingly trained artificial intelligence. Alternatively, different processing paths may also be calculated by rule-based algorithms. A combination of artificial intelligence and a rule-based algorithm is also possible within a processing path 102 in the form of a parallel connection or concatenation.

The diagnostic results 109 of the wall diagnostics may be implemented as numeric values, vectors, or matrices. Further, the probability of detection, or for the wall type classification and/or the object classification, respectively, a probability of the specified object classes and/or wall type classifications can be given for the object detection. The same may apply to the position and/or depth determination, for which corresponding probability values can also be given.

If, in addition to the radar data 103, the additional sensor information of the further sensor types is processed in a processing path 102, these may either be merged within the artificial intelligence 125 or combined by rule-based combinations.

In the post-processing of each processing path 102, of the embodiment of FIG. 3, multiple algorithm results based on multiple windows 167 may be summarized by the summary module 165. This summary can in particular be realized by majority formation, sum formation or also by multiplication of successive probability values.

Further, by clustering multiple results, for example, it is possible to detect which objects of multiple detected objects lying close to one another are the same object so that they are not incorrectly detected multiple times.

Likewise, it is possible to multiply a weighting function 177 when summarizing the results from multiple windows 167. Advantageously, the diagnostic sub-results 175 corresponding to corresponding data points in the space may be weighted with respect to positioning of the diagnostic sub-results 175 relative to a center point of the respective window 167. This is illustrated by way of example in graph b), in which the individual diagnostic sub-results 175 are weighted according to the weighting function 177 shown with respect to the center point of the window 167 shown.

According to one embodiment, the results of one processing path 102 after post-processing 163 may influence the extension of another processing path 102. Here, weighting parameters may be adjusted that may depend on the particular result from the processing path 102 for each window.

For example, the result of an object classification in which the object type 117 of an object disposed in the wall 105 is defined can be utilized to increase the weight of a wall type classification in which the wall type 123 of the respective wall 105 is determined in the post-processing at locations without objects 113, because the respective radar data 103 at these locations are less influenced by reflections of the objects 113.

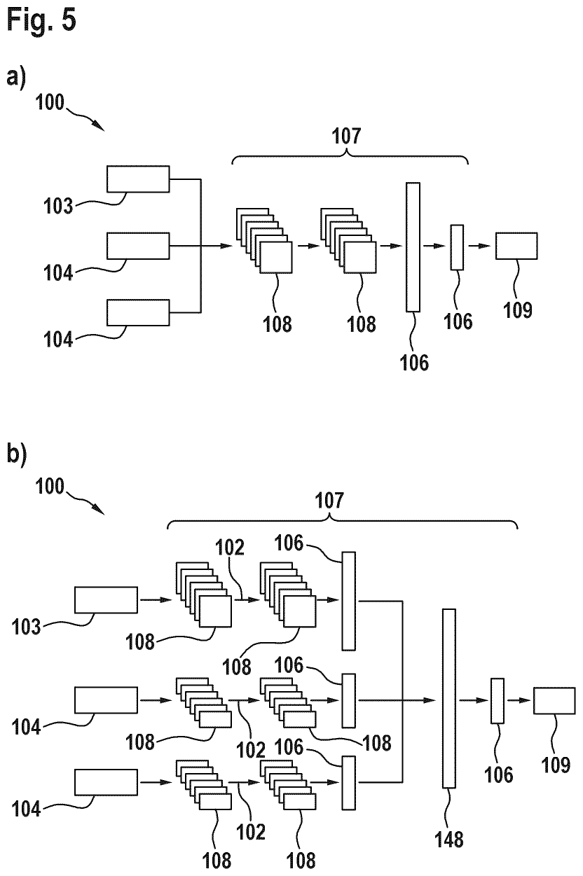

FIG. 5 shows a further schematic representation of the measuring device 100 according to a further embodiment.

Graphs a) and b) of FIG. 5 show two different alternatives of a joint data processing of radar data 103 and additional sensor information 104 by the diagnostic module 107.

Graph b) illustrates a joint processing of the radar data 103 and the additional sensor information 104 of the additional sensors by the diagnostic module 107. For this purpose, the radar data 103 and the additional sensor information 104 are collectively used as input data of the diagnostic module 107 configured as an artificial intelligence, in particular as an artificial neural network.

The diagnostic module 107 here comprises multiple convolutions 108 and multiple dense layers 106. The radar data 103 and the additional sensor information 104 are processed jointly as input data via the convolutions 108 and dense layers 106. The aforementioned diagnostic results 109 are created as output data of the diagnostic module 107, based on this.

In graph b), in contrast, the radar data 103 and the additional sensor information 104 are used as stand-alone input data of the diagnostic module 107. The diagnostic module 107 becomes multiple processing paths 102. The processing paths 102 each comprise multiple convolutions 108 and at least one dense layer 106. In the various processing paths 102, wall diagnostics are performed separately by the diagnostic module 107 based on the radar data 103 and the additional sensor information 104, respectively.

In an additional concatenation layer 148, the partial results of the partial diagnoses of the different processing paths 102 are combined and fed to a final dense layer 106. The output data of the diagnostic module 107 corresponds to the diagnostic results 109 described above.

The correspondingly configured diagnostic module 107 is designed to perform wall diagnostics as described above, including the features described above, based on the radar data 103 and the additional sensor information 104.

In the embodiment shown, the diagnostic module 107 is configured as an artificial neural network, in particular as a convolutional network. Corresponding network architectures with convolutions 108, dense layers 106, and concatenation layers 148 are known from the prior art.

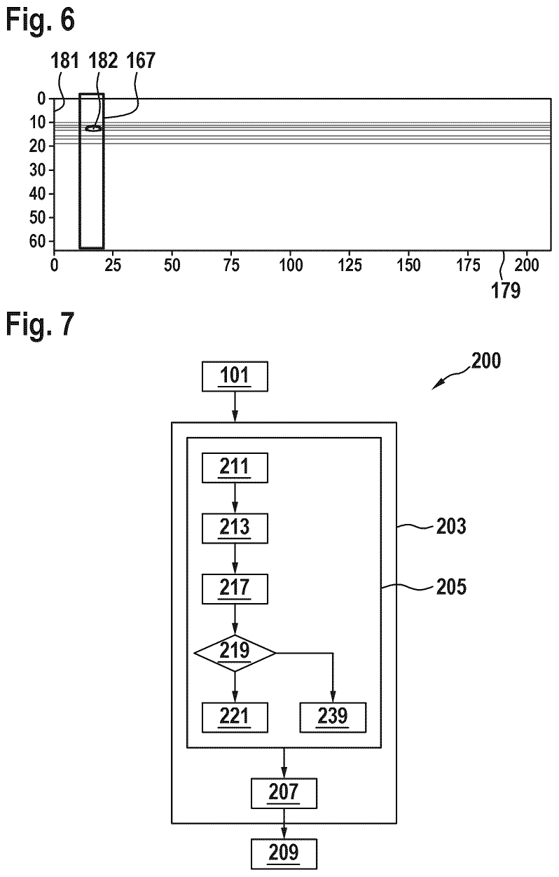

FIG. 6 shows a further schematic illustration of a measurement of the measuring device 100 according to one embodiment.

FIG. 6 shows radar data 103 captured by the measuring device 100 as the measuring device 100 moves along the direction of movement 153 relative to the wall 105 along a movement path 179. The radar data 103 is plotted in FIG. 6 for different frequencies 181. Further, a window 167 is shown in FIG. 6. The window 167 shows a contiguous spatial area extending over a sub-area of the movement path 179 and comprising radar data 103 and radar signals of a plurality of different frequencies 181.

Only one window 167 is represented in FIG. 6, by way of example. As the measuring device 100 moves along the movement path 169, corresponding windows 167 are recorded at predetermined distances, i.e., at predetermined measurement points. The windows 167 may be disposed as overlapping, wherein the overlap region representing spatial areas of the movement path 169 through at least two windows 167.

Also shown in FIG. 6 is a measurement signal 182. The measurement signal 182 may be based, for example, on an object 113 disposed in the wall 105.

To examine the wall, based on the received radar data 103 of the radar sensor unit 101 of the measurement device 100, which respectively maps the wall 105 to be diagnosed and if applicable the objects 113 disposed in the wall 105, the diagnostic module 107 performs the wall diagnostics and generates the diagnostic results 109.

In the wall diagnostics, the wall type classification is performed and the wall type 123 of the wall 105 is determined by the diagnostic module 107 based on the radar data.

Further, the object recognition of the object 113 disposed in the wall 105 is performed based on the radar data 103 and taking into account the wall type classification results, i.e. the determined wall type 123. The object recognition includes at least the object detection, i.e., determining the object position 115, and the object classification, i.e., determining the object type 117 of the object 113.

Further, the diagnostic results 109 of the display unit 111 of the measuring device 100 are provided and displayed therein. The diagnostic results comprise at least the determined wall type 123 and, if an object 113 is present, the object position 115 and the object type 117.

The analysis of the radar data 103 is carried out in the windows 167 shown above. For each window, a partial classification of the radar data 103 is performed and partial classification results of the wall type 123 are determined. The results of the wall type 123 determined for the different windows 167 are subsequently merged to an overall result in a merger.

The partial classification results represent results for different sub-areas of the wall 105. Through the merger, the partial classification results may be summarized into the overall result. The overall result is representative of a contiguous area of the wall generated by summarizing the sub-areas of the partial classification results.

The merger can be carried out in this case taking into account a weighting. The weighting may take wall type classification results into consideration with a lower weighting, such as those that deviate greatly from the wall types 123 determined for windows recorded at earlier times 167. This can prevent erroneous results from adversely affecting the wall diagnostics.

The determined wall type classification results of the wall type 123 determined for a window 167 recorded at the current time may then be compared to stored wall types 123 determined for windows 167 that were recorded at earlier times. If the comparison shows that the wall type 123 determined for a predetermined number of windows 167 deviates from that determined for the windows 167 recorded at earlier times, then the wall type 123 determined for the windows 167 recorded at later times is stored as the current wall type 123 and used for the wall diagnostics.

If a deviating wall type 123 is determined for current windows 167, but if the number of windows 167 for which the deviating wall type 123 was determined is less than the predetermined number, then the deviating wall type 123 is not considered and the wall diagnostics are continued using the wall type 123 determined based on the windows 167 which were determined earlier.

Further, movement data of the movement detection unit 141 is included when the measuring device 100 is moved along the movement path 179 and considered for determining a position of the measuring device 100 relative to the wall 105. The position of the measuring device 100 determined in this way relative to the wall 105 is considered in the wall diagnostics, in particular in the object recognition, in order to determine at least the object position 115 of the object 113 disposed in the wall 105.

When movement of the measuring device 100 relative to the wall 105 is detected, the wall diagnostics are performed by the diagnostic module 107 only at predefined measurement points. The measurement points are thereby defined by predefined distances that the measuring device 100 has traversed between the measurement points, i.e., between the performances of the wall diagnostics by the diagnostic module 107 relative to the wall 105, along the movement path 179.

If the measuring device 100 has not yet reached the next measurement point during the movement along the movement path 179, i.e. the measuring device 100 has not yet traveled the predefined distance, the radar data 103 recorded up to that point will be stored. The stored radar data 103 is then processed by the diagnostic module 107 only upon reaching the next measurement point.

FIG. 7 shows a flowchart of a method 200 for operating a measuring device 100 according to one embodiment.

To operate the measuring device 100, in a first method step 201, radar data 103 of the radar sensor unit 101 of the measuring device 100 is first received, wherein the radar data 103 depicts the wall 105 to be diagnosed.

In a further method step 203, the wall diagnostics are performed by performing the analysis of the radar data 103 generating diagnostic results 109 using the diagnostic module 107 of the measuring device 100.

For this purpose, in a method step 205 the wall type classification is performed and the wall type 123 of the wall 105 is determined.

For this purpose, in a method step 211, a partial classification is performed on individual windows 167 of the radar data 103 and partial classification results for the wall type 123 are provided.

In a method step 213, the partial classification results are merged to an overall classification result and the wall type 123 is determined based on the overall classification result.

In a further method step 217, the wall type classification results of the wall type 123 are stored.

In a method step 219, the wall type classification results of the wall type 123 determined at a current time are compared with the wall type classification results for the wall type 123 generated and stored at earlier times.

In a method step 221, the wall type classification results for the wall type 123 determined at the current time are provided, if the current wall type classification results for the wall type 123 deviate from the stored wall type classification results for the wall type 123 of a predetermined number of windows 167 of the radar data 103.

In a further method step 239, otherwise the stored wall type classification results for the wall type 123 are provided.

In a further method step 207, the object recognition is performed by the diagnostic module 107 based on the radar data 103 and taking into account the wall type classification results of the wall type 123. The object recognition comprises at least the object detection and the object classification.

In another method step 209, the diagnostic results 109 of the diagnostic module 107 are provided to a display unit 111 for displaying the diagnostic results 109. The diagnostic results 109 comprise at least the object position 115 and the object type 117 of the object 113 disposed in the wall and the wall type 123 of the wall 105 to be examined.

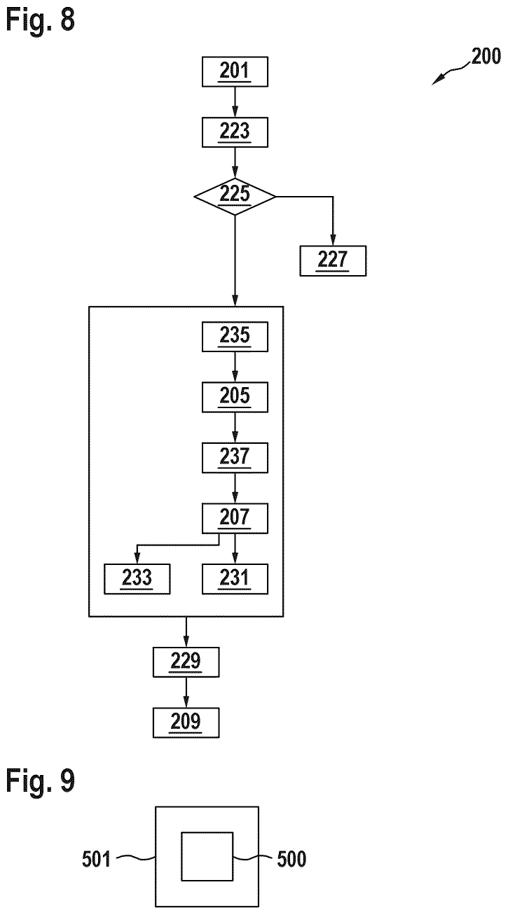

FIG. 8 shows a further flowchart of the method 200 for operating a measuring device 100 according to a further embodiment.

The embodiment shown is based on the embodiment in FIG. 7 and comprises all the method steps described there.

In deviation from the embodiment in FIG. 7, in a method step 223, the movement data of the movement detection unit 141 of the measuring device 100 is first received. The movement data here depicts the movement of the measuring device 100 relative to the wall 105 between a plurality of positions of the measuring device 100 relative to the wall 105.

In a method step 225, a check is carried out based on the movement data to determine whether the movement of the measuring device 100 relative to the wall 105 comprises a predefined distance.

If no movement by the predefined distance of the measuring device 100 relative to the wall 105 has been detected, the recorded radar data 103 is stored in a method step 227 and a new check is performed.

Conversely, if a corresponding movement of the measuring device 100 relative to the wall 105 by the predefined distance is detected, then the wall diagnostics is performed in method step 203.

Here, in a method step 231, the object depth determination is performed by the diagnostic module 107 and the object depth 119 of the object 113 in the wall 105 is determined.

Alternatively or additionally, in a method step 233, the object extension determination is performed by the diagnostic module 107 and the object extension 121 of the object 113 is determined.

Further, in a method step 235, the radar data 103 is pre-processed by the first pre-processing module 135 and input data 133 is provided to the wall type classification module 129.

Further, in a further method step 237, pre-processing of the radar data 103 is performed by the second pre-processing module 137, taking into account the provided wall type 123. Further, input data 133 is provided to the object recognition module 131 by the second pre-processing module.

FIG. 9 shows a schematic representation of a computer program product 500 comprising instructions that, when the program is executed by a data processing unit, cause the latter to perform the method 200 for operating a measuring device 100.

In the embodiment shown, the computer program product 500 is stored on a storage medium 501. The storage medium 501 can in this case be any desired storage medium known from the prior art.

What is claimed is:

1. A computer-implemented method of operating a measuring device, comprising:
receiving radar data of a radar sensor unit of the measuring device, wherein the radar data depicts a wall to be diagnosed;
performing a wall diagnostics by performing an analysis of the radar data and generating diagnostic results using a diagnostic module of the measuring device, wherein the performing the wall diagnostics comprises:
performing a wall type classification and providing wall type classification results of a wall type of the wall using the diagnostic module based on the radar data;
performing an object recognition of an object disposed in the wall using the diagnostic module based on the radar data and taking into account the wall type classification results of the wall type, wherein the object recognition comprises an object detection and an object classification; and
providing the diagnostic results of the diagnostic module to a display unit of the measuring device for displaying the diagnostic results to a user of the measuring device, wherein the diagnostic results comprise at least one object position of the object in the wall and an object type of the object and/or the wall type of the wall.

2. The method according to claim 1, wherein the received radar data comprises a plurality of radar signals of different frequencies reflected by the wall, and wherein the received radar data is summarized to a plurality of windows.

3. The method according to claim 2, wherein performing the wall type classification comprises:
performing partial classifications on individual windows of the radar data and providing partial classification results of the wall type; and
merging a plurality of partial classification results to an overall classification result and determining the wall type based on the overall classification result.

4. The method according to claim 3, wherein the merger is effected by performing a merger algorithm, and/or wherein, during the merger, the partial classification results are considered with a weighting with respect to the results of the object recognition.

5. The method according to claim 1, wherein performing the wall type classification comprises:
storing the wall type classification results for the wall type;
comparing the currently determined wall type classification results for the wall type with stored wall type classification results for the wall type; and
providing the current wall type classification results for the wall type if the current wall type classification results for the wall type deviate from the stored wall type classification results for the wall type for a predetermined number of windows of the radar data.

6. The method according to claim 1, wherein:
the radar data is received for a plurality of positions of the measuring device relative to the wall, and
the method further comprises receiving movement data of a movement detection unit of the measuring device, wherein the movement data represents a movement of the measuring device relative to the wall between the plurality of positions of the measuring device relative to the wall.

7. The method according to claim 6, further comprising:
checking, based on the movement data of the movement detection unit, whether a movement of the measuring device relative to the wall by a predefined distance has been detected;
if no movement has been detected, storing the radar data and performing the check again; and
if movement by the predefined distance has been detected, performing the wall diagnostics based on the radar data using the diagnostic module.

8. The method according to claim 1, wherein the wall diagnostics further comprises:
summarizing sub-objects detected and classified at various positions of the measuring device relative to the wall, based on radar data to a contiguous object, if there is a predefined distance dependency between the sub-objects.

9. A computing unit configured to perform the method of operating a measuring device according to claim 1.

10. A computer program product comprising instructions which, when the program is executed by a data processing unit, cause the data processing unit to perform the steps of the method for operating a measuring device according to claim 1.

11. The method according to claim 1, wherein the measuring device includes a wall diagnostic device.
